(19) United States
(12) Patent Application Publication
(10) Pub. No.: US 2008/0273349 A1
(43) Pub. Date: Nov. 6, 2008

(54) LIGHT SOURCE APPARATUS AND LIGHT REFLECTION DEVICE THEREOF

(75) Inventors: Po-Hung Yao, Kaohsiung County (TW); Wen-Hsun Yang, Taipei City (TW); Ying-Hsiu Lin, Yilan County (TW); Yu-Nan Pao, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 11/775,234

(22) Filed: Jul. 10, 2007

(30) Foreign Application Priority Data
May 2, 2007 (TW) 96115633

(51) Int. Cl. F21V 7/04

(52) U.S. Cl. 362/609

(57) ABSTRACT

A light source apparatus including a light emitting module and a reflection microstructure layer is provided. The light emitting module emits a light. The reflection microstructure layer is disposed at the base of the light source apparatus and reflects an incident light emitted by the light emitting module in substantially a same direction.

### CROSS-REFERENCE TO RELATED APPLICATION

This application claims the priority benefit of Taiwan application serial no. 96115633, filed May 2, 2007. All disclosure of the Taiwan application is incorporated herein by reference.

### BACKGROUND OF THE INVENTION

1. Field of the Invention

The present invention relates to a light source apparatus having a reflection microstructure layer.

2. Description of Related Art

Light source apparatus has many applications, for example, which has been applied to flat panel displays as backlight modules. In a conventional backlight module, diffusers, brightness enhance films (BEFs), or dual BEFs (DBEFs) are used for obtaining even and concentrated light.

FIG. 1 is a cross-sectional view of a conventional direct type light source apparatus. Referring to FIG. 1, the bottom of the conventional light source apparatus 100 is a reflective surface, and the downward lights 104 and 106 emitted by a light tube 102 are reflected by the reflective surface. Since the reflective surface is a smooth surface, the lights are reflected according to optical reflection rule. Accordingly, the reflected lights are scattered to a great extent and which impairs the brightness enhance effect of the light source apparatus.

The conventional direct type light source apparatus has low light emitting efficiency and divergent light field, therefore a plurality of optical films has to be used for adjusting the distribution of the light field thereof. Accordingly, the conventional direct type light source apparatus has low optical efficiency and high fabricating cost.

Besides, the optical films are usually disposed on the light tube and diffuser, thus, in the conventional technique, moire may be caused due to interferences between the films.

The backlight module described above uses a large number of films, therefore the optical efficiency of the backlight module is reduced, the fabricating cost thereof is increased, and the assembly yield thereof is limited. Accordingly, a backlight module having high optical efficiency and low fabricating cost is to be developed.

### SUMMARY OF THE INVENTION

Accordingly, the present invention is directed to a light source apparatus having an optical microstructure layer, wherein the distribution of lights emitted by a light source is controlled so as to produce a particular light field through appropriate design of the optical microstructure layer, and accordingly the backlight module may be simplified and the optical efficiency thereof may be improved.

The present invention is directed to a light source apparatus including a light emitting module and a reflection microstructure layer. The reflection microstructure layer is disposed at the base of the light source apparatus and reflects an incident light emitted by the light emitting module to substantially the same direction.

The present invention further provides a light reflection device for reflecting an incident light. The light reflection device includes a reflection microstructure layer having a reflective surface and an accidented surface microstructure. The reflection microstructure layer receives the incident light and reflects it to substantially the same direction.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a conventional direct type light source apparatus.

FIG. 2 is a cross-sectional view of a light source apparatus having a reflection microstructure layer according to an embodiment of the present invention.

FIG. 3 is a cross-sectional view of a reflection microstructure layer in a light source apparatus according to an embodiment of the present invention.

FIG. 4 is a cross-sectional view of a reflection microstructure layer in a light source apparatus according to an embodiment of the present invention.

FIG. 5 is a cross-sectional view of a reflection microstructure layer in a light source apparatus according to an embodiment of the present invention.

FIG. 6 is a cross-sectional view of a reflection microstructure layer in a light source apparatus according to an embodiment of the present invention.

FIG. 7 is a diagram illustrating the fabrication of a reflection microstructure layer according to an embodiment of the present invention.

FIG. 8 is a graph illustrating simulated light fields before and after adjusting the microstructure of the reflection microstructure layer in FIG. 3.

FIG. 9 is a perspective view of a direct type light source apparatus according to an embodiment of the present invention.

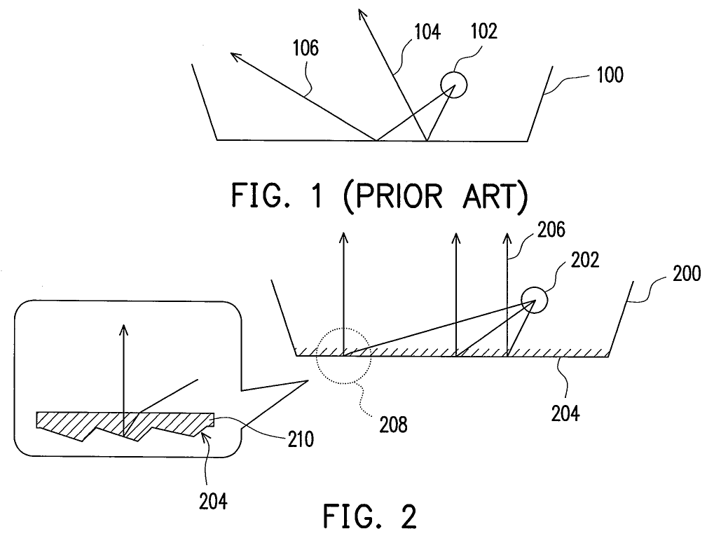

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

In the present invention, for example for a light box serving as the light source apparatus, a microstracture design and distribution is disposed at the base of a light source apparatus or the base of the light box so that the light emitting efficiency and control on the distribution of the initial light field of the light source apparatus are both improved, and accordingly the number of films used in a backlight module and the fabricating cost thereof are both reduced.

Moreover, since the microstructure device is disposed below the light tube and the diffuser, moire is avoided and the requirement in the quality of the microstructure device is reduced, and accordingly the fabrication yield of the microstructure device is improved. Furthermore, in the present invention, by adjusting the structure pattern of the microstructure device, the reflected light field can be controlled for compensating a dark zone between the light tubes. The uneven brightness and the usage of the number of the light tubes can be reduced, and accordingly the fabrication cost of the backlight module is effectively reduced.

Embodiments of the present invention will be described below with reference to accompany drawings; however, these embodiments are not intended for limiting the present invention.

FIG. 2 is a cross-sectional view of a light source apparatus having a reflection microstructure layer according to an embodiment of the present invention. Referring to FIG. 2, the light source apparatus 200, which can include various device elements, includes for example a light emitting module 202 and a reflection microstructure layer 204, wherein the light emitting module emits a light, and the reflection microstructure layer 204 is disposed at the base of the light source apparatus 200. The light emitting module 202 may be a strip lamp, and the downward light emitted by the light emitting module 202 is received and reflected by the reflection microstructure layer 204. The reflection microstructure layer 204 may adopt the structure as in area 208, wherein the reflection microstructure layer 204 includes a transmissive base layer 210 and an accidented microstructure pattern formed on the surface of the transmissive base layer 210. In addition, a light reflecting film 204 may be farther coated over the surface having the accidented microstructure pattern as a reflective surface. The light 206 is reflected within substantially a range from a direction by adjusting the angle of the microstructure pattern. Accordingly, besides reflecting the incident light, the reflection microstructure layer 204 also enhances the brightness of the light.

It should be noted that the light emitting module 202 may be a general light emitting device such as a strip lamp, a point bulb, or a light emitting diode (LED). The pattern of the reflection microstructure layer 204 may be one-dimensional or two-dimensional according to the light emitting module 202 adopted. The number of the light emitting module 202 is determined according to the actual need. Embodiments of the present invention with various designs of the reflection microstructure layer will be described below; however, the present invention is not limited to these embodiments.

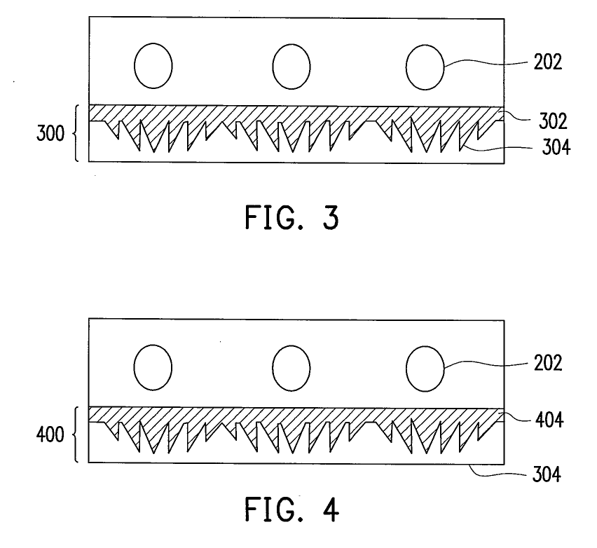

FIG. 3 is a cross-sectional view of a reflection microstructure layer in a light source apparatus according to an embodiment of the present invention. Referring to FIG. 3, in the present embodiment, the light emitting module 202 in the light source apparatus may be a strip lamp. The reflection microstructure layer 300 may have a transmissive material base layer 302 as its main body. An accidented surface microstructure is formed on a surface of the transmissive material base layer 302, for example, the surface different as the light emitting module 202. The accidented pattern of the accidented surface microstructure may change regularly regarding the position of the lamp. Moreover, since the lamp also emits light upwardly, thus, by adjusting the microstructure below the light emitting module 202, the intensity of the reflected light is reduced, and accordingly uneven brightness around the light emitting module 202 is also reduced.

Moreover, a reflective surface 304, for example, a light reflecting film, is disposed on the surface of the accidented surface microstructure for reflecting the incident lights in re-use. The material of the transmissive material base layer 302 may have a refractive index (RI), and which may be a single-layer or multiple-layer RI material. The RI of the material of the transmissive material base layer 302 may cause total internal reflection. The spaces between the accidented structure units of the accidented surface microstructure can be adjusted to an appropriate value according to the actual requirement, and which may measure from microns to centimeters. Besides, the accidented structure units of the accidented surface microstructure may be sharp-angled strip structures corresponding to the position of the lamp as to a one-dimensional design and may also be pyramidal structures as to a two-dimensional design, and these two structures may be mixed and adopted together. The apex angle of the sharp-angled strip structure or the pyramidal structure may be between 20° and 170°. Besides, the two base angles of the pyramidal structure may be asymmetry, for example, between 5° and 90°. Moreover, the accidented structure units may also be elliptic cylinder structures, and the curvature radius thereof may be between 10 μm and 500 μm. In other words, the accidented structure units may be of any accidented structure, such as pyramidal, spherical, non-spherical, or polygonal.

The accidented structure units may be alternatively arranged evenly or unevenly, or may also be arranged as a single continuous or discontinuous matrix. The arrangement of the accidented structure units may be in any two-dimensional function, including random arrangement.

Referring to FIG. 3 again, the transmissive material base layer 302 with biases represents a single object. However, a substrate may be further disposed below the transmissive material base layer 302 for forming the reflection microstructure layer 300 with the transmissive material base layer 302, wherein the interface between the substrate and the transmissive material base layer 302 may be the reflective surface 304.

FIG. 4 is a cross-sectional view of a reflection microstructure layer in a light source apparatus according to an embodiment of the present invention. Referring to FIG. 4, the reflection microstructure layer 400 includes a transmissive material base layer 404 and a reflective surface 304. The transmissive material base layer 404 has similar accidented microstructure as the transmissive material base layer 302 illustrated in FIG. 3; however, here the reflective surface 304 is disposed at a different position. In the present embodiment, the reflective surface 304 is disposed separately. In addition, the transmissive material base layer 404 with biases is a single object. However, a substrate may be further disposed below the transmissive material base layer 404 for forming the reflection microstructure layer 400 with the transmissive material base layer 404.

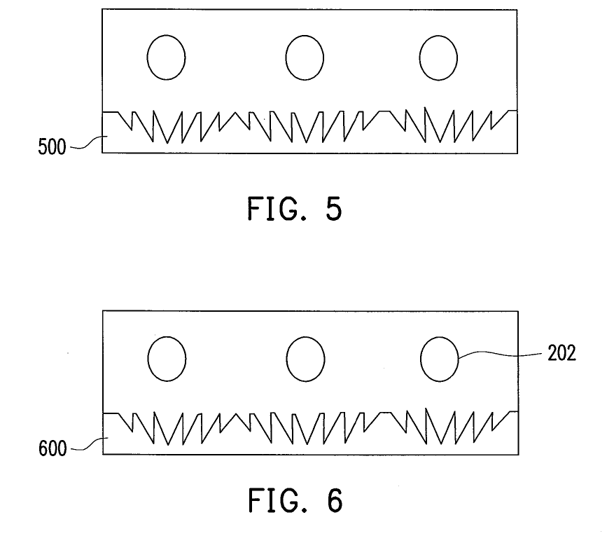

FIG. 5 is a cross-sectional view of a reflection microstructure layer in a light source apparatus according to an embodiment of the present invention. Referring to FIG. 5, the reflection microstructure layer 500 is fabricated with a transmissive material and which has an accidented microstructure layer on the surface adjacent to the light emitting module 202. In this design, the reflective surface is disposed on the surface of the accidented microstructure layer.

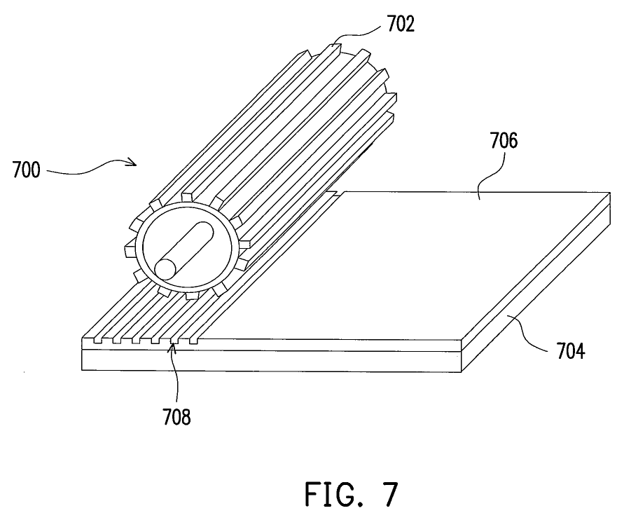

FIG. 6 is a cross-sectional view of a reflection microstructure layer in a light source apparatus according to an embodiment of the present invention. Referring to FIG. 6, the reflection microstructure layer 600 is fabricated with a transmissive material and has an accidented microstructure layer on the surface thereof adjacent to the light emitting module 202. However, in this design, the reflective surface is disposed on the bottom surface of the reflection microstructure layer 600 instead of on the surface of the accidented microstructure layer.

The reflection microstructure layers described above both reflect and concentrate lights, namely, the lights can be reflected in substantially the same direction (for example, in a vertical direction), thus, the purpose of brightness enhancement is achieved. The microstructure of the reflection microstructure layer can be fabricated on a suitable material once the shape thereof is determined. FIG. 7 is a diagram illustrating the fabrication of a reflection microstructure layer according to an embodiment of the present invention. Referring to FIG. 7, a string of microstructures 702 is fabricated according to the desired shape, and these microstructures 702 are disposed on a roller for forming a microstructure mold 700. Additional, a UV-curing transmissive material 706 may be formed on a plastic substrate 704. The roller having the microstructure pattern is rolled over the transmissive material 706 before it is cured in order to leave accidented strip structures 708 of desired shape on the transmissive material 706. In the present embodiment, the pattern of the microstructure changes periodically; however, the change pattern of the microstructures is not limited herein. The microstructure layer is formed on the plastic substrate 704 after the transmissive material 706 is UV-cured. Next, a light reflecting film may be coated over the microstructure layer according to the requirement to form the reflection microstructure layer. The light reflecting film is fabricated on the surface of the accidented microstructure, as illustrated in FIG. 3 and FIG. 5. Besides, the light reflecting film may also be fabricated on the reverse side of the plastic substrate 704, as illustrated in FIG. 4 and FIG. 6. However, the fabrication of the light reflecting film is not limited to foregoing embodiments.

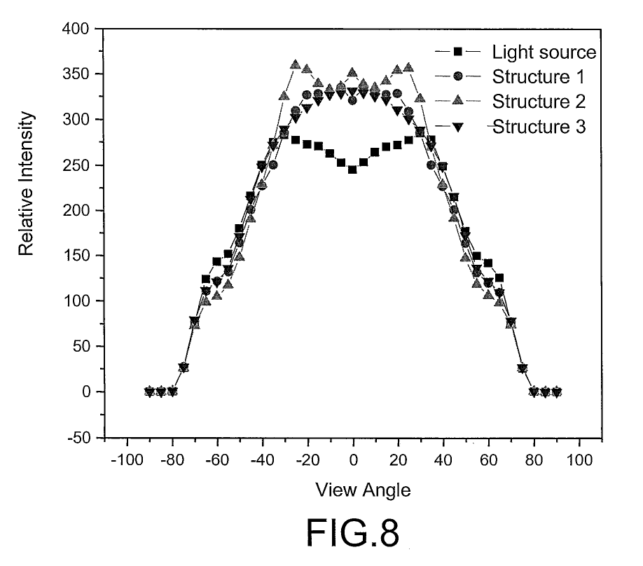

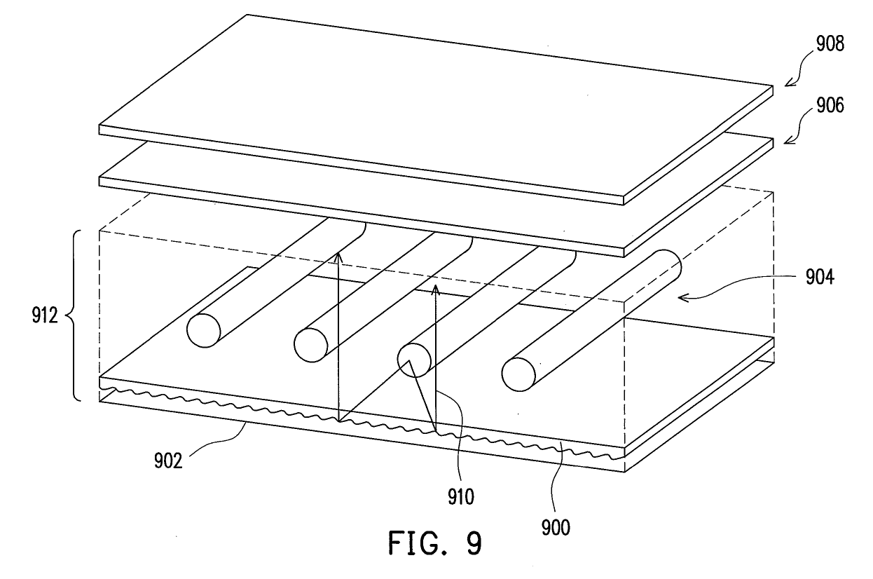

Improved performance by the design of the present invention can be observed from simulative experiments. FIG. 8 is a graph illustrating simulated light fields before and after adjusting the microstructure of the reflection microstructure layer in FIG. 3. In FIG. 8, square data points denote a light field curve without microstructure design, round data points denote a light field curve with a design of evenly-arranged pyramidal microstructures, triangular data points denote a light field curve with a design that the apex angles of pyramidal microstructures are adjusted along with different position of the light source, and inverted triangular data points denote a light field curve with a design of elliptic cylinder microstructures instead of pyramidal microstructures. Visual angle in the figure represents the angle of the observation apparatus. For example, visual angle of 0° represents the light intensity of a vertical surface to the light source apparatus. As shown in FIG. 8, the light source apparatus in the present invention can reflect the incident light within substantially a small range, namely, the light source apparatus in the present invention can enhance light brightness.

FIG. 9 is a perspective view of a direct type light source apparatus according to an embodiment of the present invention. Referring to FIG. 9, a reflection microstructure layer 900 as illustrated in FIG. 4 has a reflective surface 902 disposed at the bottom surface of the light source apparatus. A light emitting module 904 is disposed on the reflection microstructure layer 900, and the light emitting module 904 may be composed of a plurality of light tubes. The light emitting module 904 and the reflection microstructure layer 900 may form a light source apparatus 912. The light 910 emitted by the light tube is reflected in an almost vertical direction by the reflection microstructure layer 900 so that the brightness of the light is enhanced. Those mechanical supporting components and related circuits should be understood by those having ordinary skill in the art, therefore will not be described herein.

Generally, a diffuser 906 and a prism strip layer 908 may be further disposed at the back of the light source apparatus 912 for improving the light emitting efficiency thereof. The diffuser 906 makes the light even, and the prism strip layer 908 is used as a brightness enhance film (BEF) for reflecting the light close to a normal which is vertical to the light output surface.

The present invention provides a microstructure device for totally reflecting an incident light in a particular direction, wherein the microstructure device may be disposed at the base of a direct type light source apparatus. Thus, the conventional problem of uncontrollable distribution of reflected light field is resolved. The arrangement and shape of the microstructure units on the microstructure device can be changed according to the position of the light source and the desired light field distribution. The material of the microstructure device is transmissive and a film is coated over the surface thereof for reflecting lights, and the distribution of the reflected light field through surface reflection and internal total reflection is designed according to the actual need. By adjusting the reflection microstructure layer of the microstructure device, for example, by inhibiting light field of large angle and increasing light field of central visual angle, even and concentrated light can be obtained, and brightness of the light can be enhanced.

In the present invention, an effective output light regulation is performed to the backlight module by generating a source light field suitable to the optical film. Moreover, in the present invention, the number of CCFL tubes and the concentration of the diffuser are reduced due to the effective regulation of the source light field; therefore the fabricating cost of the light source apparatus is reduced. Furthermore, in the present invention, the microstructure device is disposed between the light tube and the diffuser, so that uneven brightness and fabrication defects of the microstructure device are reduced, and fabrication yield of the product is effectively improved.

The microstructure optical device provided by the present invention can be implemented through ultra-precision machining technique for forming single crystal diamond tool on the metal cavity and roll forming technique for UV-curing the transmissive material, so as to engrave the microstructure on the cavity onto the optical base material. Thus, the present invention has advantages in actual mass-production.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light source apparatus, comprising:
a light emitting module, emitting a light; and
a reflection microstructure layer, disposed at the base of the light source apparatus, the reflection microstructure layer receiving an incident light emitted by the light emitting module and reflecting the incident light to substantially a same direction.

2. The light source apparatus according to claim 1, wherein the reflection microstructure layer comprises:
a transmissive material base layer;
an accidented surface microstructure, formed on the transmissive material base layer; and
a reflective surface, disposed on the accidented surface microstructure, the reflective surface reflecting the incident light.

3. The light source apparatus according to claim 2 further comprising a substrate forming a structural body with the transmissive material base layer.

4. The light source apparatus according to claim 2, wherein the reflective surface comprises a film.

5. The light source apparatus according to claim 1, wherein the reflection microstructure layer comprises:
a transmissive material base layer;
an accidented surface microstructure, formed on the transmissive material base layer at a different side as the light emitting module; and
a reflective surface, disposed close to the accidented surface microstructure, the reflective surface reflecting the incident light.

6. The light source apparatus according to claim 5 further comprising a substrate forming a structural body with the transmissive material base layer.

7. The light source apparatus according to claim 1, wherein the reflection microstructure layer comprises:
a transmissive material base layer;
an accidented surface microstructure, formed on the transmissive material base layer at the same side as the light emitting module; and
a reflective surface, disposed on the accidented surface microstructure, the reflective surface reflecting the incident light.

8. The light source apparatus according to claim 7, wherein the reflective surface comprises a film.

9. The light source apparatus according to claim 1, wherein the reflection microstructure layer comprises:
a transmissive material base layer;
an accidented surface microstructure, formed on the transmissive material base layer at the same side as the light emitting module; and
a reflective surface, disposed at one side of the transmissive material base layer different from the accidented surface microstructure, the reflective surface reflecting the incident light.

10. The light source apparatus according to claim 1 further comprising a diffuser and a prism strip layer disposed at one side of the light emitting module opposite to the reflection microstructure layer.

11. A light reflection device, for reflecting an incident light, the light reflection device comprising:
a reflection microstructure layer, having a reflective surface and an accidented surface microstructure, the reflection microstructure layer receiving the incident light and reflecting the incident light to substantially a same direction.

12. The light reflection device according to claim 11, wherein the reflection microstructure layer comprises:
a transmissive material base layer;
an accidented surface microstructure, formed on the transmissive material base layer at a different side to the light emitting module; and
a reflective surface, disposed on the accidented surface microstructure, the reflective surface reflecting the incident light.

13. The light reflection device according to claim 12 further comprising a substrate forming a structural body with the transmissive material base layer.

14. The light reflection device according to claim 12, wherein the reflective surface comprises a film.

15. The light reflection device according to claim 11, wherein the reflection microstructure layer comprises:
a transmissive material base layer;
an accidented surface microstructure, formed on the transmissive material base layer at a different side to the light emitting module; and
a reflective surface, disposed close to the accidented surface microstructure, the reflective surface reflecting the incident light.

16. The light reflection device according to claim 15 further comprising a substrate forming a structural body with the transmissive material base layer.

17. The light reflection device according to claim 11, wherein the reflection microstructure layer comprises:
a transmissive material base layer;
an accidented surface microstructure, formed on the transmissive material base layer at the same side as the light emitting module; and
a reflective surface, disposed on the accidented surface microstructure, the reflective surface reflecting the incident light.

18. The light reflection device according to claim 17, wherein the reflective surface comprises a film.

19. The light reflection device according to claim 11, wherein the reflection microstructure layer comprises:
a transmissive material base layer;
an accidented surface microstructure, formed on the transmissive material base layer at the same side as the light emitting module; and
a reflective surface, disposed at one side of the transmissive material base layer different from the accidented surface microstructure, the reflective surface reflecting the incident light.
